(19) United States
(12) Patent Application Publication
(10) Pub. No.: US 2010/0006200 A1
(43) Pub. Date: Jan. 14, 2010

(54) PNEUMATIC TIRE

(76) Inventor: Touru FUKUMOTO, Kobe-shi (JP)

Correspondence Address: BIRCH STEWART KOLASCH & BIRCH, PO BOX 747, FALLS CHURCH, VA, 22040-0747, US

(21) Appl. No.: 12/436,505

(22) Filed: May 6, 2009

(30) Foreign Application Priority Data
Jul. 10, 2008 (JP) 2008-180420

(51) Int. Cl. B60C 9/28

(52) U.S. Cl. 152/527

(57) ABSTRACT

A pneumatic tire comprises a tread reinforcing belt, and the belt includes a band composed of at least one helically wound rayon cord, wherein the rayon cord is composed of (1) a single bunch of filaments final-twisted together, or (2) 2 or 3 bunches of nontwisted filaments which bunches are final-twisted together, or (3) 2 to 3 strands final-twisted together wherein each of the strands is a bunch of filaments primarily-twisted together, and the final-twist number (turn/10 cm) and a total decitex value D (dtex) of the rayon cord satisfy the following conditions: 1840=<D=<5520; and 1.0=<N×D̂0.5×10̂−3=<5.3×10̂−4×D+0.41.

### BACKGROUND OF THE INVENTION

The present invention relates to a pneumatic tire, more particularly to a tread reinforcing band suitable for an eco tire comprising raw materials derived from non-petroleum resources.

In recent years, a pneumatic tire, a large part of which is made from raw materials derived from non-petroleum resources has been proposed, for example, as disclosed in the United states Patent Application publication Nos. 2003-0100661-A1. Such a pneumatic tire is called eco tire. In the eco tires currently available on the market, the percentage of the weight of non-petroleum raw materials to the overall weight of the tire reached to 97%.

On the other hand, in the case of common pneumatic tires for passenger cars, the tread portion is usually provided with a steel cord breaker and a nylon cord band in order to improve the high-speed durability, steering stability and the like. But, rayon cords are rarely used as band cords because the elastic limit of a rayon cord is low when compared with nylon cords, and accordingly, it is highly possible that during running the rayon cords cause plastic deformation and are broken. Namely, the fatigue resistance is low. Thus, it is difficult to maintain the initial strength and durability for a long period of tire life time.

### SUMMARY OF THE INVENTION

It is therefore, an object of the present invention to provide a pneumatic tire so called eco tire, in which a tread reinforcing band is made of a rayon cord in order to increase the percentage of the raw tire materials derived from non-petroleum resources, and

the initial strength or durability of the rayon cord band can be maintained for a long period of tire life time by specifically designing the cord structure.

According to the present invention, a pneumatic tire comprises a tread portion, a pair of sidewall portions, a pair of bead portions each with a bead core therein, a carcass extending between the bead portions through the tread portion and sidewall portions, and a tread reinforcing belt disposed radially outside the carcass in the tread portion, the belt including a band composed of at least one helically wound rayon cord, wherein

the rayon cord is composed of (1) a single bunch of filaments final-twisted together, or (2) 2 or 3 bunches of nontwisted filaments which bunches are final-twisted together, or (3) 2 to 3 strands final-twisted together wherein each of the strands is a bunch of filaments primarily-twisted together, and

the final-twist number (turn/10 cm) and a total decitex value D (dtex) of the rayon cord satisfy the following conditions:

1840=<D=<5520, and

1.0=<N×D̂0.5×10̂−3=<5.3×10̂−4×D+0.41.

### BRIEF DESCRIPTION OF THE DRAWINGS

FIG. 1 is a cross sectional view of a pneumatic tire according to the present invention.

FIG. 2 is a perspective view of rayon cords embedded in a topping rubber in a form of a tape used to form the tread reinforcing band.

FIGS. 3(a)-3(e) are diagrams showing the cord structures for the rayon cord.

FIG. 4 is a distribution map of the test tires.

### DESCRIPTION OF THE PREFERRED EMBODIMENTS

Embodiments of the present invention will now be described in detail in conjunction with accompanying drawings.

In the drawings, pneumatic tire 1 according to the present invention is an eco tire for passenger cars comprising a tread portion 2, a pair of axially spaced bead portions 4 each with a bead core 5 therein, a pair of sidewall portions 3 extending between the tread edges and the bead portions, a carcass 6 extending between the bead portions 4, and a tread reinforcing belt disposed radially outside the carcass 6 in the tread portion 2.

The carcass 6 is composed of at least one ply 6A of cords arranged radially at an angle of from 80 to 90 degrees with respect to the tire equator C. The carcass ply 6A extends between the bead portions 4 through the tread portion 2 and sidewall portions 3 and is turned up around the bead cores 5 in the respective bead portions from the inside to the outside of the tire so as to form a pair of turnup portions 6b and a main portion 6a therebetween. In this embodiment, the carcass 6 is composed of a single ply 6A of cords arranged radially at an angle of substantially 90 degrees.

Preferably, a rayon cord ply rubberized by a topping rubber comprising natural rubber and silica as the filler material is used. Namely, a topping rubber made form mainly non-petroleum materials is used.

Between the main portion 6a and turnup portion 6b in each of the bead portions, there is disposed a bead apex 8 extending radially outwardly from the bead core 5 in a tapered manner. As the bead apex 8, a hard rubber which is preferably made from mainly natural rubber and silica, namely, non-petroleum materials is used.

Inside the carcass 6, an innerliner made of an air-impermeable rubber is disposed. In this embodiment, a reformulated natural rubber is used as the air-impermeable rubber.
Further, outside the carcass 6 in the tread portion 2 and sidewall portions 3, a tread rubber and sidewall rubber each made of a reformulated natural rubber are disposed.

Between the carcass 6 and the tread rubber, the above-mentioned belt is disposed. The belt includes a breaker 7 and a band 9.

The breaker 7 comprises two cross plies 7A and 7B of cords laid at an angle of from 10 to 40 degrees with respect to the tire equator C. In this embodiment, the breaker 7 is disposed on the radially outside of the carcass crown portion, and composed of only two cross plies of steel cords: a radially inner ply 7A and a radially outer ply 7B. The topping rubber made from mainly natural rubber and silica filler is used.

The band 9 is composed of at least one rayon cord 11 helically wound at a small angle of not more than 5 degrees with respect to the tire circumferential direction.

In this embodiment, the band 9 is disposed on the radially outside of the breaker 7. Thus, the band 9 controls an expansion of the breaker 7 during high speed running and the buckling of the breaker 7 during cornering, and thereby the high-speed durability and maneuverability can be improved.

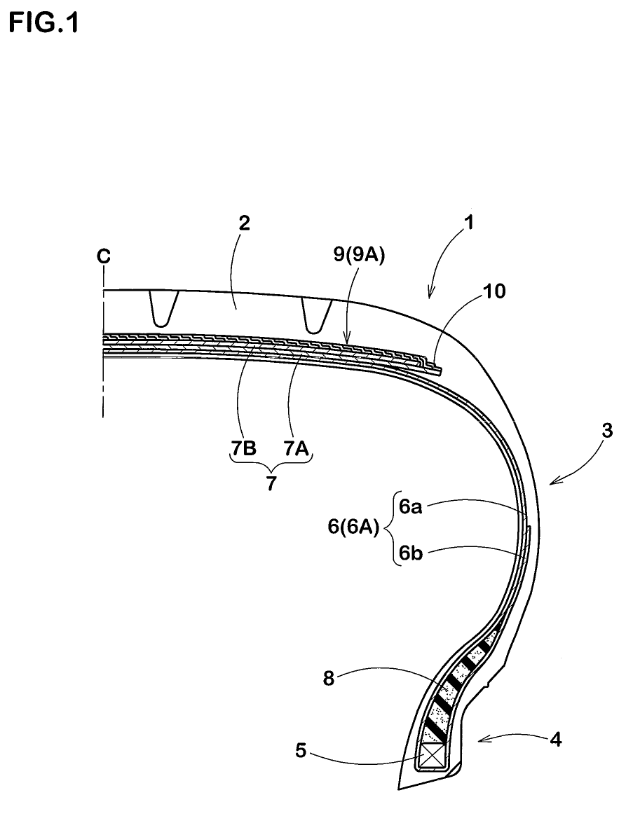

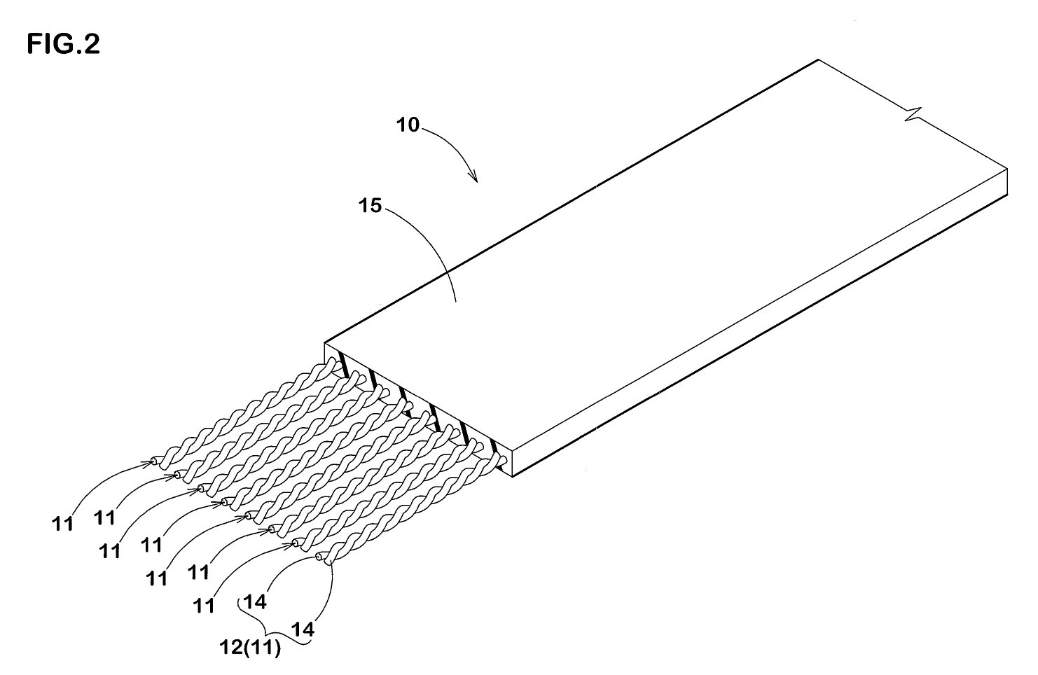

In order to improve the productivity, the band 9 can be formed by helically winding a tape 10. The tape 10 is an assembly of parallel rayon cords 11 embedded in an unvulcanized topping rubber 15 in a form of a tape as shown in FIG. 2. In the example shown FIG. 1, the tape 10 is wound into a single layer 9A so that the edges thereof are overlapped with each other. It is however, also possible to wind the tape 10 such that the edges are spaced apart from each other between the adjacent windings, or the edges closely contact with each other between the adjacent windings.

The band 9 in this example is wound across the entire width of the breaker 7 (full-width band). However, it is also possible to wound around only the edge portions of the breaker 7 (edge band). Further, it is also possible to use a combination of the full-width band and edge band.

In the tape 10 in this embodiment, a plurality of (eight) rayon cords 11 are arranged side by side and embedded in the unvulcanized topping rubber 15. But, it is also possible to use such a tape 10 in which a single rayon cord 11 is embedded along the length of the tape. The cross sectional shape of the tape is substantially rectangle. But, a round cross sectional shape can be employed particularly in the case of the single cord.

The rayon cord 11 is made up of a large number of continuous filaments made of rayon, and the total decitex value D thereof is set in a range of from 1840 to 5520 dtex.

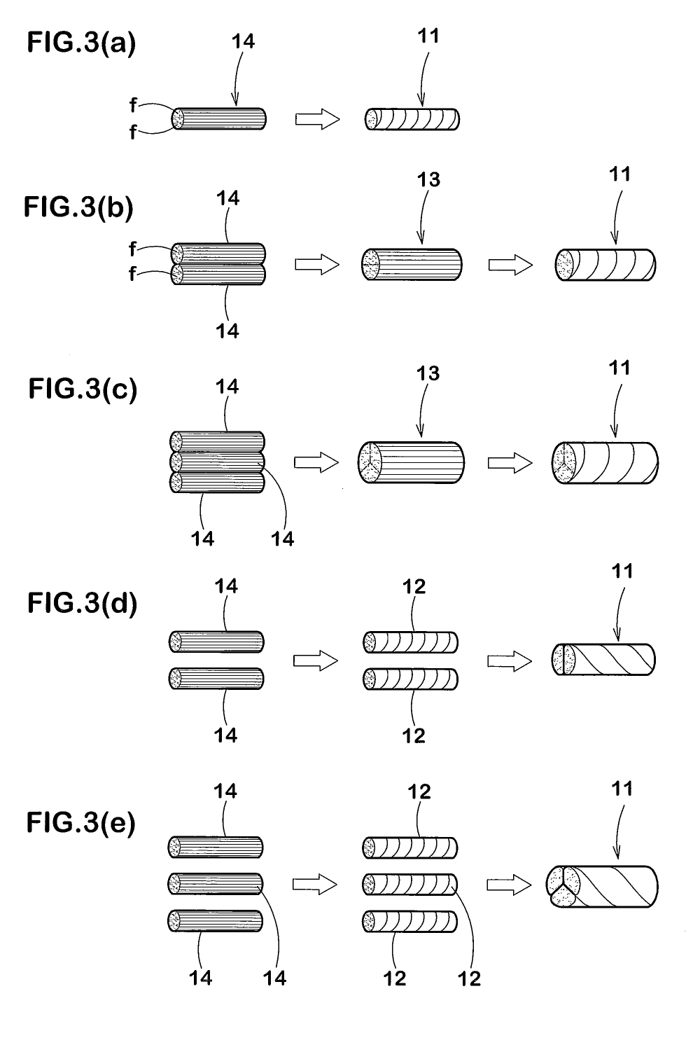

FIGS. 3(a)-3(e) show the cord structures for the rayon cord 11.

In FIG. 3(a), the rayon cord 11 is a unidirectionally twisted yarn which is formed by twisting a single bunch 14 of nontwisted rayon filaments together. In this case, the primary twisting is the final-twisting.

In FIG. 3(b), the rayon cord 11 is a unidirectionally twisted yarn which is formed by twisting two bunches 14 of nontwisted rayon filaments together. In this case too, the primary twisting is the final-twisting.

In FIG. 3(c), the rayon cord 11 is a unidirectionally twisted yarn which is formed by twisting three bunches 14 of nontwisted rayon filaments together. Also, the primary twisting is the final-twisting.

In the case of FIG. 3(b) or 3(c), before final-twisting the two or three bunches 14, an intermediate 13 of the nontwisted rayon filaments bunched into a substantially round cross-sectional may be formed, and the intermediate 13 is final twisted.

In FIG. 3(d), the rayon cord 11 is a bidirectionally twisted yarn which is formed by final-twisting two strands 12 together, wherein each of the two strands 12 is formed by primarily-twisting a single bunch 14 of nontwisted rayon filaments together. In this case, the final-twisting direction is opposite to the primarily-twisting direction.

In FIG. 3(e), the rayon cord 11 is a bidirectionally twisted yarn which is formed by final-twisting three strands 12 together, wherein each of the three strands 12 is formed by primarily-twisting a single bunch 14 of nontwisted rayon filaments together. In this case, the final-twisting direction is opposite to the primarily-twisting direction.

In the case that the rayon cord 11 is the bidirectionally twisted yarn as shown in FIGS. 3(d) and 3(e), the number of primarily-twist is the same as the number of final twist. But, it is also possible that the number of final twist is 110 to 120% of the number of primarily-twist. In this case, the rayon cord 11 can be improved in the modulus and fatigue resistance in a well balanced manner.

The reason for limiting the total decitex value D of the rayon cord 11 as above is as follows: If the total decitex value D is less than 1840 dtex, the cord strength is decreased and there is a possibility that the durability of the band 9 becomes insufficient. If the total decitex value D is more than 5520 dtex, the thickness of the tape 10 is increased, and the moldability of the band becomes worse.

Preferably, the total decitex value D of the rayon cord 11 is set to be not less than 2440 dtex, more preferably not less than 3680 dtex in order to achieve the required cord strength.

In general, there is a tendency that the elastic limit of a rayon cord becomes low when compared with nylon cords. Accordingly, it is highly possible that during running the rayon cords 11 in the jointless band 9 cause plastic deformation and are broken. As a result the durability of the band is lost in early stages. However, by specifically setting the twist coefficient T together with the total decitex value D (dtex), it is possible to maintain or improve the strength and durability of the band 9.

Here, the twist coefficient T is

T=N×D̂0.5×10̂−3

wherein
N is the final-twist number (turn/10 cm) of the rayon cord 11.

If the twist coefficient T is increased over 5.3×10̂−4×D+0.41, then the fatigue resistance of the rayon cord is significantly decreased, and the rayon cord becomes very liable to break. If the twist coefficient T is less than 1.0, then the elongation of the rayon cord decreases, the fatigue resistance is decreased, and the rayon cord 11 becomes liable to break. Further, the distance between the breaker cords and the band cords becomes very small during vulcanizing the tire in a mold and as a result, the durability of the tire is decreased.

Therefore, the twist coefficient T is set in a range of not less than 1.0 and not more than 5.3×10̂−4×D+0.41.

In order to reduce the deformation of the band 9 and thereby to prevent the rayon cords 11 form breaking, it is preferable that the above-mentioned topping rubber 15 is a high modulus rubber having a complex elastic modulus (E*) of from 4.0 to 10.0 MPa.

Here, the complex elastic modulus (E*) is measured according to Japanese industrial standard JIS K 6394, using a viscoelastic spectrometer under the following conditions.

| | |
|---|---|
| measuring mode: | tensile deformation |
| initial strain: | 10% |
| amplitude: | +−2% |
| frequency: | 10 Hz |
| temperature: | 70 degrees C. |

If the complex elastic modulus (E*) of the topping rubber 15 is less than 4.0 MPa, it is difficult to reduced the deformation of the band 9 caused during running. It is therefore, preferable that the complex elastic modulus (E*) of the topping rubber 15 is not less than 4.5 MPa, more preferably not less than 5.0 MPa, still more preferably not less than 5.5 MPa.
On the other hand, if the complex elastic modulus (E*) is excessively increased, the viscosity of the unvulcanized topping rubber is increased and the workability becomes worse. Further, the ride comfort of the tire tends to deteriorate. Therefore, the complex elastic modulus (E*) of the topping rubber 15 is preferably not more than 10.0 MPa, more preferably not more than 9.0 MPa, still more preferably not more than 8.0 MPa.

In the eco tire, it is desired that the topping rubber 15 comprises 95% or more by mass of raw materials derived from non-petroleum resources.

The topping rubber 15 is mainly made from rubber polymer, reinforcing agent and extender oil, therefore, natural rubber (inclusive of reformulated natural rubber) is preferably used as the rubber polymer. In comparison with synthetic rubber, in the case of natural rubber, it is possible to reduce the amount of vulcanization accelerator which is a material derived from petroleum resources. Thus, in this view too, the use of natural rubber is preferable.

As to the reinforcing agent (or filler) derived from non-petroleum resources, for example: inorganic materials (silica, sericite, calcium carbonate, clay, alumina, talc, magnesium carbonate, magnesium hydroxide, aluminium hydroxide, magnesium oxide, titanium oxide and the like); vegetable polysaccharide (starch, cellulose and the like); and animal polysaccharide (chitin, chitosan and the like) can be used. In particular, the use of silica is preferred. Nevertheless, according to need, for example, in order to provide an electrically conductivity as well as reinforcing effect, a small amount of carbon black can be used together.

In the case that silica is used as the main reinforcing agent or filler, the BET specific surface of the silica is preferably set in a range of 150 to 250 sq.m/g.

If less than 150 sq.m/g, it is difficult to provide a sufficient reinforcing effect. If more than 250 sq.m/g, since the dispersibility becomes low, the silica is liable to agglutinate.

When the inorganic material is used as the reinforcing agent, a silane coupling agent is preferably used together.

As the silane coupling agent, for example,
BiS[3-(triethoxysilyl)propyl] tetrasulfide,
Bis[3-(trimethoxysilyl)propyl] tetrasulfide,
Bis[2-(triethoxysilyl)propyl] tetrasulfide,
(3-Mercapto propyl)triethoxysilane, and
(2-Mercaptoethyl)trimethoxysilane
   can be used alone or in combination. Among them
Bis[3-(triethoxysilyl)propyl] tetrasulfide OR
(3-Mercaptopropyl)triethoxysilane
   is preferably used. Especially, in view of workability,
Bis[3-(triethoxysilyl)propyl] tetrasulfide
   is preferred.

In the case that the inorganic material and silane coupling agent are used together, it is preferable to use 3 to 20% by mass of the silane coupling agent.

As to the extender oil derived from non-petroleum resources, vegetable oil or fat, for example, ricinus, cotton oil, linseed oil, colza oil, soy-bean oil, palm oil, coconut oil, peanut oil, rosin oil, pine oil, pine tar, tall oil, corn oil, rice oil, safflower oil, sesame oil, olive oil, sunflower oil, palm kernel oil, camellia oil, jojoba oil, macadamia ternifolia, wood oil and the like can be used.

Especially the use of colza oil, palm oil and cocoanut oil is preferred in view of the softening effect and cost.
In particular, vegetable oil and fat whose degree of unsaturation is small, for example: semi-drying oil whose iodine value is 100 to 130; nondrying oil whose iodine value is not more than 100; and solid oil can be used preferably.
If the iodine value is more than 130, the tangent delta is increased, and as a result, the rolling resistance is liable to increase and the steering stability is liable to deteriorate. If the iodine value is less than 100, it becomes difficult to soften the rubber, Further, the oil is liable to separate out from the vulcanized rubber, and there is a tendency that properties tend to deteriorate by heat aging.
comparison Tests

Pneumatic tires of size 195/65R15 (rim size: 15×6J) for passenger cars having the structure shown in FIG. 1 were made and tested for the durability of the band.

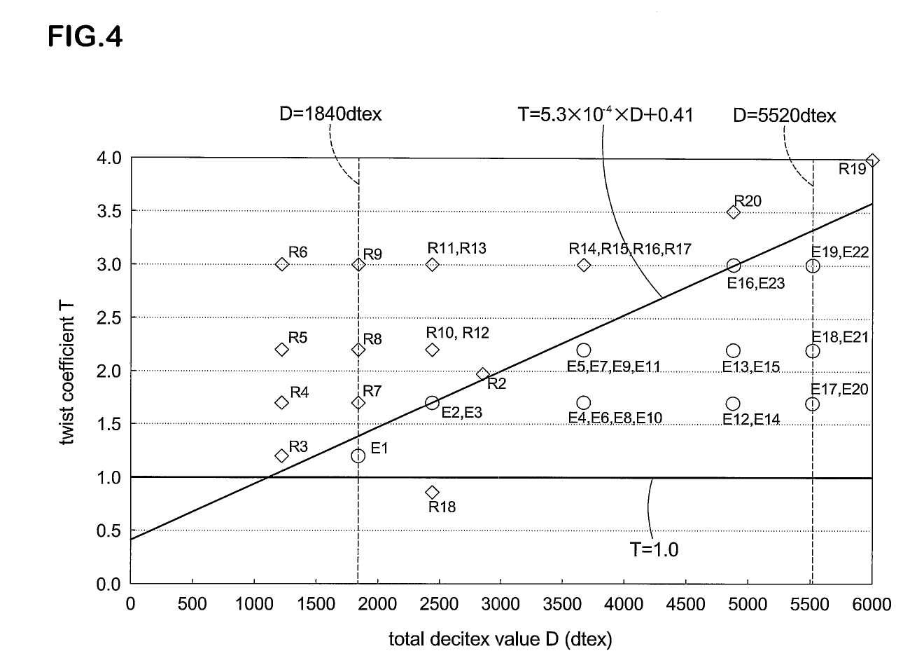

The band was formed by helically winding a tape (width 10.0 mm, thickness 1.49 mm, eight cords embedded). The specifications of the band cords are shown in Table 1 and FIG. 4. The composition of the topping rubber is as follows.

Topping rubber for Band cord (unit: mass %)
materials derived from non-petroleum resources

| | | |
|---|---|---|
| natural rubber | 100 | (RSS#3) |
| silica | 55 | Ultrasil VN3, Degussa-Huels AG |
| coupling agents | 4.4 | Si-69, Degussa-Huels AG |
| vegetable oil | 3 | purified palm oil J(S), |
| | | Nisshin oil Mills, Ltd. |
| stearic acid | 1.5 | TSUBAKI, NOF Corporation |
| zinc oxide | 3.5 | zinc oxide grade 2, Mitsui Mining |
| | | And Smelting Company, Ltd. |
| sulfur | 3.5 | powder sulfur, Tsurumi Chemical |
| | | Industory Co., Ltd. |

material derived from petroleum resources

| | | |
|---|---|---|
| accelerator | 0.9 | Nocceler NS, Ouchi Shinko Chemical |
| | | Industrial Co., Ltd. |
| age resistor | 0 | |
| adhesive agent | 0 | |

### High-Speed Durability Test

According to Regulation No. 30 of ECE, Annex VII, Procedure for load/speed performance tests, a high speed durability test was made using a tire test drum. When the tire could continuously run for 20 minutes or more at a speed of 200 km/h without being broken, the tire was appraised as passable. When could not, the tire was appraised as being failed the test. The results are shown in Table 1. tire pressure 280 kPa

### Cord Breaking Test

Using the tire test drum, the test tire was continuously run for 30000 km at a speed of 80 km/h and a tire load of 6.96 kN. (tire pressure 280 kPa) Then, the tire was disassembled and checked if the band cords were broken. The results are shown in Table 1,

From the test results, it was confirmed that the durability of the rayon band according to the present invention can be maintained.

TABLE 1

| Tire | Ref. 1 | Ref. 2 | Ref. 3 | Ref. 4 | Ref. 5 | Ref. 6 | Ref. 7 | Ref. 8 | Ref. 9 | Ref. 10 | Ref. 11 |
|---|---|---|---|---|---|---|---|---|---|---|---|
| Band | non | | | | | | | | | | |
| cord material | — | nylon66 | rayon | rayon | rayon | rayon | rayon | rayon | rayon | rayon | rayon |
| cord structure *1 | — | 1400/2 | 1220/1 | 1220/1 | 1220/1 | 1220/1 | 1840/1 | 1840/1 | 1840/1 | 2440/1 | 2440/1 |
| | — | BdTY | UdTY | UdTY | UdTY | UdTY | UdTY | UdTY | UdTY | UdTY | UdTY |
| total decitex value D (dtex) | — | 2800 | 1220 | 1220 | 1220 | 1220 | 1840 | 1840 | 1840 | 2440 | 2440 |
| twist number N (turn/10 cm) | — | 36 | 34 | 49 | 63 | 86 | 40 | 51 | 70 | 45 | 61 |
| twist coefficient T | — | 1.9 | 1.2 | 1.7 | 2.2 | 3.0 | 1.7 | 2.2 | 3.0 | 2.2 | 3.0 |
| value of 5.3 × 10\hat{ }−4 × D + 0.41 | — | 1.9 | 1.1 | 1.1 | 1.1 | 1.1 | 1.4 | 1.4 | 1.4 | 1.7 | 1.7 |
| Test results | | | | | | | | | | | |
| high-speed durability | failed | pass | pass | pass | pass | pass | pass | pass | pass | pass | pass |
| cord breaking | — | no | yes | yes | yes | yes | yes | yes | yes | yes | yes |

| Tire | Ref. 12 | Ref. 13 | Ref. 14 | Ref. 15 | Ref. 16 | Ref. 17 | Ref. 18 | Ref. 19 | Ref. 20 | Ex. 1 | Ex. 2 |
|---|---|---|---|---|---|---|---|---|---|---|---|
| Band | | | | | | | | | | | |
| cord material | rayon | rayon | rayon | rayon | rayon | rayon | rayon | rayon | rayon | rayon | rayon |
| cord structure *1 | 1220/2 | 1220/2 | 1220/3 | 1220//3/1 | 1840/2 | 1840//2/1 | 2440/1 | 2000/3 | 1220/4 | 1840/1 | 2440/1 |
| | BdTY | BdTY | BdTY | UdTY | BdTY | UdTY | UdTY | BdTY | BdTY | UdTY | UdTY |
| total decitex value D (dtex) | 2440 | 2440 | 3660 | 3660 | 3680 | 3680 | 2440 | 6000 | 4880 | 1840 | 2440 |
| twist number N (turn/10 cm) | 45 | 61 | 50 | 50 | 49 | 49 | 18 | 52 | 50 | 28 | 34 |
| twist coefficient T | 2.2 | 3.0 | 3.0 | 3.0 | 3.0 | 3.0 | 0.9 | 4.0 | 3.5 | 1.2 | 1.7 |
| value of 5.3 × 10\hat{ }−4 × D + 0.41 | 1.7 | 1.7 | 2.3 | 2.3 | 2.4 | 2.4 | 1.7 | 3.6 | 3.0 | 1.4 | 1.7 |
| Test results | | | | | | | | | | | |
| high-speed durability | pass | pass | pass | pass | pass | pass | failed | pass | pass | pass | pass |
| cord breaking | yes | yes | yes | yes | yes | yes | no | yes | yes | no | no |

| Tire | Ex. 3 | Ex. 4 | Ex. 5 | Ex. 6 | Ex. 7 | Ex. 8 | Ex. 9 | Ex. 10 | Ex. 11 | Ex. 12 | Ex. 13 |
|---|---|---|---|---|---|---|---|---|---|---|---|
| Band | | | | | | | | | | | |
| cord material | rayon | rayon | rayon | rayon | rayon | rayon | rayon | rayon | rayon | rayon | rayon |
| cord structure *1 | 1220/2 | 1220/3 | 1220/3 | 1220//3/1 | 1220//3/1 | 1840/2 | 1840/2 | 1840//2/1 | 1840//2/1 | 2440/2 | 2440/2 |
| | BdTY | BdTY | BdTY | UdTY | UdTY | BdTY | BdTY | UdTY | UdTY | BdTY | BdTY |
| total decitex value D (dtex) | 2440 | 3660 | 3660 | 3660 | 3660 | 3680 | 3680 | 3680 | 3680 | 4880 | 4880 |
| twist number N (turn/10 cm) | 34 | 28 | 36 | 28 | 36 | 28 | 36 | 28 | 36 | 24 | 31 |
| twist coefficient T | 1.7 | 1.7 | 2.2 | 1.7 | 2.2 | 1.7 | 2.2 | 1.7 | 2.2 | 1.7 | 2.2 |
| value of 5.3 × 10\hat{ }−4 × D + 0.41 | 1.7 | 2.3 | 2.3 | 2.3 | 2.3 | 2.4 | 2.4 | 2.4 | 2.4 | 3.0 | 3.0 |
| Test results | | | | | | | | | | | |
| high-speed durability | pass | pass | pass | pass | pass | pass | pass | pass | pass | pass | pass |
| cord breaking | no | no | no | no | no | no | no | no | no | no | no |

| Tire | Ex. 14 | Ex. 15 | Ex. 16 | Ex. 17 | Ex. 18 | Ex. 19 | Ex. 20 | Ex. 21 | Ex. 22 | Ex. 23 |
|---|---|---|---|---|---|---|---|---|---|---|
| Band | | | | | | | | | | |
| cord material | rayon | rayon | rayon | rayon | rayon | rayon | rayon | rayon | rayon | rayon |
| cord structure *1 | 2440//2/1 | 2440//2/1 | 2440//2/1 | 1840/3 | 1840/3 | 1840/3 | 1840//3/1 | 1840//3/1 | 1840//3/1 | 2440/2 |
| | UdTY | BdTY | BdTY | UdTY | UdTY | BdTY | BdTY | BdTY | BdTY | UdTY |
| total decitex value D (dtex) | 4880 | 4880 | 4880 | 5520 | 5520 | 5520 | 5520 | 5520 | 5520 | 4880 |
| twist number N (turn/10 cm) | 24 | 31 | 43 | 23 | 30 | 40 | 23 | 30 | 40 | 43 |
| twist coefficient T | 1.7 | 2.2 | 3.0 | 1.7 | 2.2 | 3.0 | 1.7 | 2.2 | 3.0 | 3.0 |
| value of 5.3 × 10\hat{ }−4 × D + 0.41 | 3.0 | 3.0 | 3.0 | 3.3 | 3.3 | 3.3 | 3.3 | 3.3 | 3.3 | 3.0 |
| Test results | | | | | | | | | | |
| high-speed durability | pass | pass | pass | pass | pass | pass | pass | pass | pass | pass |
| cord breaking | no | no | no | no | no | no | no | no | no | no |

*1) UdTY = Unidirectionally twisted yarn
BdTY = Bidirectionally twisted yarn

1. A pneumatic tire comprising
a tread portion,
a pair of sidewall portions,
a pair of bead portions each with a bead core therein,
a carcass extending between the bead portions through the tread portion and sidewall portions, and
a tread reinforcing belt disposed radially outside the carcass in the tread portion, wherein
the belt includes a band composed of at least one helically wound rayon cord,
the rayon cord is composed of (1) a single bunch of filaments final-twisted together, or (2) 2 or 3 bunches of nontwisted filaments which bunches are final-twisted together, or (3) 2 to 3 strands final-twisted together wherein each of the strands is a bunch of filaments primarily-twisted together, and
the final-twist number (turn/10 cm) and a total decitex value D (dtex) of the rayon cord satisfy the following conditions:
1840=<D=<5520, and
1.0=<N×D̂0.5×10̂−3=<5.3×10̂−4×D+0.41.

2. The tire according to claim 1, wherein
the rayon cord is composed of (2) 2 or 3 bunches of nontwisted filaments which bunches are final-twisted together, and the total decitex value D is 2440 to 5520 dtex.

3. The tire according to claim 1, wherein
the rayon cord is composed of (3) 2 to 3 strands final-twisted together wherein each of the strands is a bunch of filaments primarily-twisted together, and the total decitex value D is 2440 to 5520 dtex.

4. The tire according to claim 1, 2 or 3, wherein
a topping rubber of the band has a complex elastic modulus (E*) of from 4.0 to 10.0 MPa at a temperature of 70 degrees c and frequency of 10 Hz.

5. The tire according to claim 1, wherein
said at least one helically wound rayon cord of the band is a plurality of rayon cords, and the band is formed by helically winding a tape of topping rubber in which the rayon cords are embedded along the length of the tape.

6. The tire according to claim 1, wherein
the belt further includes a breaker comprising two cross plies of steel cords laid at an angle of from 10 to 40 degrees with respect to the tire equator.

7. The tire according to claim 1, wherein
the carcass comprises a ply of rayon cords arranged radially at an angle of from 80 to 90 degrees with respect to the tire equator.
